(19) United States
(12) Patent Application Publication
(10) Pub. No.: US 2017/0034131 A1
(43) Pub. Date: Feb. 2, 2017

(54) SYSTEM AND METHOD FOR ENCRYPTION OF DIGITAL CONTENT BASED ON A MODIFIED ONE TIME PAD ALGORITHM

(71) Applicants: Todor Yotkov Yotov, Sofia (BG); Georgi Todorov Gerasimov, Sevlievo (BG); Stefan Stefanov Petrounov, Sofia (BG); Pavel Georgiev Gerasimov, Sevlievo (BG)

(72) Inventors: Todor Yotkov Yotov, Sofia (BG); Georgi Todorov Gerasimov, Sevlievo (BG); Stefan Stefanov Petrounov, Sofia (BG); Pavel Georgiev Gerasimov, Sevlievo (BG)

(21) Appl. No.: 15/221,234

(22) Filed: Jul. 27, 2016

Related U.S. Application Data
(60) Provisional application No. 62/197,594, filed on Jul. 28, 2015.

(51) Int. Cl. H04L 29/06; H04L 9/08

(52) U.S. Cl. CPC H04L 63/045; H04L 9/0841; H04L 63/061; H04L 2209/24

(57) ABSTRACT

The present invention provides for a hybrid encryption and decryption apparatus using elements of object-related encryption. The system utilizes a one time pad algorithm and allows for encryption of any digital data, including but not limited to text, picture, audio and video by using an arbitrary object as an information carrier enabling the creation of encryption keys of non-restrained length. Encryption keys are dynamically created and synchronized for all session users and exist only within the session without the need to be pre-defined, stored or archived unless archiving is mandated by user workflows outside the system. Synchronization is based on the exchange of both trivial and useful information bundled in information containers that can be of a fixed or variable length.

### CROSS-REFERENCE TO RELATED APPLICATIONS

The present application claims priority to U.S. Provisional Patent Application Ser. No. 62/197,594, filed on Jul. 28, 2015 entitled “System and Method for Encryption of Digital Content Based on a Modified One Time Pad Algorithm”, the disclosure of which is hereby incorporated in its entirety at least by reference.

### BACKGROUND OF THE INVENTION

1. Field of the Invention

The present invention relates computer and mobile security, and more particularly a system and method for encryption of digital content based on a modified one time pad algorithm.

2. Description of Related Art

In the art of encryption, there are existing systems and solutions for the generation of encryption keys which are subject to the following problems: an ongoing need to prove logically and empirically the resistance against crypto attacks and breaches; and quantitative assessment is always contingent on the level of development of the available systems and software tools as of the specific period of assessment. Furthermore, when symmetric encryption algorithms with a common encryption key are utilized the problems are magnified by the issues with the distribution of the encryption keys among the system users or session participants.

In standard encryption methods known in the art, users cannot exchange encrypted messages unless they use a common encryption key, and users cannot exchange an encryption key unless a separate secure channel, which guarantees the confidentiality and security of the exchange is available.

Consequently, there is a need for a method to securely transfer data electronically across a network that addresses the challenges of the prior art without the need of a special apparatus or programming resource.

### BRIEF SUMMARY OF THE INVENTION

In one embodiment of the present invention a method is provided, comprising steps: (a) generating a encryption key, wherein the encryption key is generated during an information exchange process between one or more session participants using an open communication channel; (b) synchronizing the encryption key to encrypt defined information within a cryptosystem with a symmetric key; and (c) renewing the encryption key by transmitting service information and useful information bundled in information containers, wherein service information is a trivial data piece consisting of information noise.

In one embodiment, in step (a), the information exchange process can dynamically switch between an encrypted and non-encrypted regime. In another embodiment, in step (a), the digital data that is encrypted is broken down to a number of identical or heterogeneous information slices denoted as quants which can be as little as the smallest indivisible information structure for the digital data. In one embodiment, each quant can be encrypted by a separate encryption key. In one embodiment, the encryption key comprises a N-bit length having an even or odd number of bits, wherein the encryption key may be dynamically changed or renewed in equal or varying time intervals. In yet another embodiment, the N-bit length of the encryption key is larger than the length of the quant of digital data that is being encrypted. In one embodiment, in step (a), a digital or analogous object is broken down to its smallest indivisible information elements. In one embodiment, the digital or analogous object is a picture, text, audio, video, website element, television report, live performance, medical means, chemical compound, or any element with a clear information structure. In another embodiment, the smallest indivisible information elements of the information structure of the digital or analogous objects are used for the generation of the encryption keys. In one embodiment, the digital or analogous objects are accessed by the session participants via independent open channels. In yet another embodiment, in step (c), the information containers comprise a fixed or variable length.

In another aspect to the invention, a system for encrypting digital data is provided, comprising: a network connected computerized appliance having a processor and coupled to a data repository, the processor executing software from a tangible medium, the software providing an interactive interface to an encryption system, the system enabling a session participants to: log on and exchange information comprising digital data with other session participants, wherein the digital data is encrypted comprising steps: (a) generating a encryption key, wherein the encryption key is generated during the information exchange between the session participants using an open communication channel; (b) synchronizing the encryption key to encrypt defined information within a cryptosystem with a symmetric key; and (c) renewing the encryption key by transmitting service information and useful information bundled in information containers, wherein service information is a trivial data piece consisting of information noise.

In one embodiment, the digital data that is encrypted is broken down to a number of identical or heterogeneous information slices denoted as quants which can be as little as the smallest indivisible information structure for the digital data. In one embodiment, each quant can be encrypted by a separate encryption key. In another embodiment, the encryption key comprises a N-bit length having an even or odd number of bits, wherein the encryption key may be dynamically changed or renewed in equal or varying time intervals. In yet another embodiment, the N-bit length of the encryption key is larger than the length of the quant of digital data that is being encrypted. In one embodiment, in step (a), a digital or analogous object is broken down to its smallest indivisible information elements. In another embodiment, the digital or analogous object is a picture, text, audio, video, website element, television report, live performance, medical means, chemical compound, or any element with a clear information structure. In one embodiment, the smallest indivisible information elements of the information structure of the digital or analogous objects are used for the generation of the encryption keys. In yet another embodiment, the digital or analogous objects are accessed by the session participants via independent open channels.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is an architectural diagram of a computer network system according to an embodiment of the present invention.

FIG. 2 is a diagram illustrating a method for encryption key generation according to an embodiment of the present invention.

FIG. 3 is a diagram illustrating an encryption matrix according to an embodiment of the present invention.

FIG. 4 is a diagram illustrating an encryption matrix according to an embodiment of the present invention.

FIG. 5A is a graph illustrating synchronization of an information transmission according to an embodiment of the present invention.

FIG. 5B is a diagram illustrating a process of generating and exchanging encryption keys using an open communication channel for exchanging information according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a system and method for encryption of digital content based on a modified one time pad algorithm.

It is a particular advantage of the present invention to provide an encryption system in which only open communication channels are used, without the need for secured channel when sharing common secret information. It is a further particular advantage of the present invention to provide an encryption system in which encryption keys are dynamically produced and synchronized at all ends without the need to exchange or store the encryption keys and without excessive key generation costs or close-form access to the utilized keys. Yet is a further particular advantage of the present invention to provide an encryption system in which the treatment of insider and outsider access is treated uniformly providing no operational risks with individuals stealing, leaking, or misplacing information, including executives and information technology (IT) personnel.

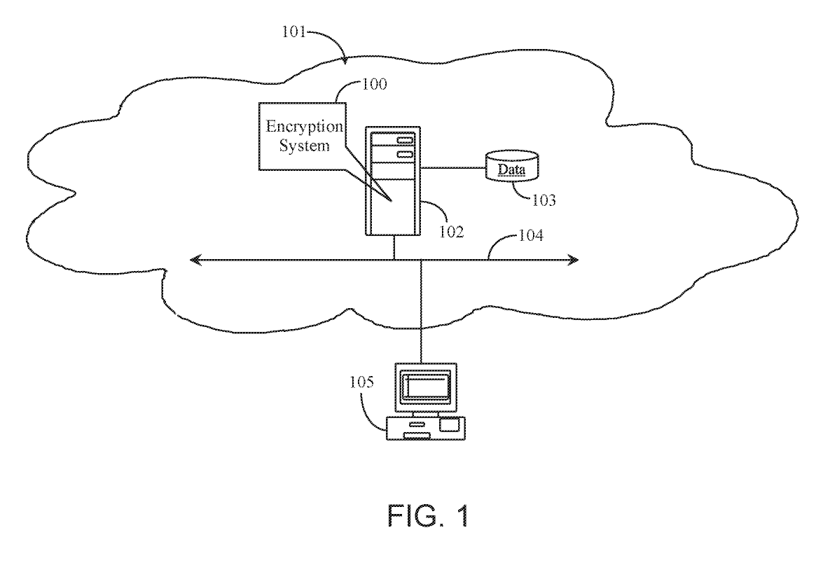

FIG. 1 is an architectural diagram of a computer network system 101 according to an embodiment of the present invention. The computer network system may be any type of network environment or medium, including but not limited to local area network (LAN), wireless LAN, Internet, or any other telecommunication network allowing computers to exchange data. The system comprises one or more network connected servers 102 executing an encryption system 100 from non-transitory media. In one embodiment, the one or more network connect servers comprise tangible medium including volatile and/or non-volatile memory. Server 102 is connected to a data repository 103, which may be any sort of data storage known in the art. Users (1-n) 105 are connected to the network-connected server, allowing users 105 access to the encryption system via network backbone 104. The users may assess the system on any computerized device known in the art, including but not limited to personal computers and mobile devices.

In one embodiment, the system uses analogue or digital objects for the creation of encryption keys without the need for a database or cloud platform. Objects can be defined as external information carriers including but not limited to any digital object on the Internet, a publicly accessible network, any object that has readable information structure such as text, video, images, web site elements, excerpts of television reports or live performances, medical means, chemical compounds, or any element with a clear information structure. Objects are used for the creation and synchronization of common encryption keys among users. In one embodiment, when a communication setting is initiated, users exchange information on which information carrier(s) they should be referring to, how the array of encryption keys should be extracted, from which parts of the information carrier(s), and on the sequence, as well as other properties prescribing the utilization of the encryption keys. Each transmission allows for more than one information carrier to be utilized. For instance, an exemplary information carrier may be a photo stored at a publicly available web address together with the prescriptions of which sector the photo, as well as which properties of which pieces of that information object should be used for the key generation and in what method.

In one embodiment, each encryption key generation is performed autonomously within a communication session and the generated keys are unique for the current communication session and for each consecutive communication session. Thus, encryption keys are dynamically created and renewed multiple times during the current communication session. The encryption keys only exist within the communication session and are not pre-defined, communicated or stored. In one embodiment, each encryption key may have a different length no less than the output message or data piece that is being encrypted, i.e., the encryption key always has a higher bit count than that of the output message or data piece. Furthermore, encryption keys with odd bit counts are allowed.

In one embodiment, in a communication session users do not have access to the encryption keys; the users include but are not limited to the sender, the recipient, IT personnel, executive personnel, and third parties. In another embodiment, within each communication session, a unique set of encryption keys is generated for each sender-recipient pair which cannot be utilized by another pair or within another communication session. The identification of the users is done through a plurality of markers that are only valid within the current communication session. The plurality of markers include but are not limited to types, structures, settings and preference sets for time, wave, position and sequence. In one embodiment, these markers are dynamic by character and are not limited by time or particular sequence. In one embodiment, each encrypted message or data piece is treated as an object. As a security feature, the objects are formed such that any in-session parameter change or tampering with any sequence related to the objects will activate the destruction of the objects.

The system does not require synchronization in a communication session, as the communication session is not a continuous process, the communication session is formed by multiple separate information slices, herein denoted as quants, which are independent and are the building blocks of the information object. In each case, these building blocks (quants) are the smallest indivisible information structure for the particular case. In one embodiment, information transfer utilizes a number of independent information channels. The system allows for the simultaneous utilization of more than one information channel and also for dynamic shifts among channels.

In one embodiment, the system provides for the creation and synchronization of N-bit length encryption keys per session wherein each encryption key may be dynamically changed or renewed in equal or varying time intervals. The system allows for communication structures that overlap in time and/or context, wherein messages may be broken down in a number of pieces limited only by the 1-bit-lower-bound for an individual data piece. The pieces are then packaged in sets, herein denoted as Deltas. Each individual Delta holds the prescription for the next-in-line event, i.e. for the processing of the subsequent Delta. In one embodiment, the pieces can overlap. For instance, if a secret message contains the word SECRET, the following pieces can be positioned in different Deltas: S, E, C, RET (S-E-C-RET), but the position breakdown could also be SE, ECR, RET (SE-ECR-RET). Each newly initiated session may process one or more Delta transmissions and the sessions need not be sequential. The method of breaking down the encrypted content is not subject to logical ordering when broken down into Deltas, thus the position breakdowns can vary. For instance, using the same example, the Delta transmission sequence can be Deltas containing E, S, RET, C, respectively.

In one embodiment, the system allows for the mixing of encrypted and non-encrypted in-session transmissions as well as for the mixing of different types of encryption within the session. The Deltas may contain useful information, that is desired to be delivered securely, or the Deltas may lack useful information, and only contain trivial information and information noise.

In one embodiment, each Delta contains information on the event that should follow, including the prescription on what to do with the Delta that is received next and also the failsafe provisions to identify a corrupted activity. The prescription for the first Delta to be processed within the transmission is created with the initial user synchronization when the first encryption keys are generated based on the external information carriers.

In one embodiment, an individual Delta may be included in a transport container. Transport containers are shells for the transmission of information, either digital or analogous, and contain service information, including but not limited to any type of technical socket, device, environment, or transmission. In one embodiment, transport containers may contain information that is not considered a subject of the secured transfer. For instance, transport containers may contain useful information, disinformation packages, and/or information noise. Disinformation is information that is identical to the useful information that is encrypted in a trivial way, which is easy to intercept and decipher, or intentionally made to stand out as contextually important. In one embodiment, an individual Delta may be a transport container for an additional Delta or Deltas. In some embodiments, the transport containers do not need to contain data pieces that are of the same type as the useful information data, which is to be transmitted and decrypted at the receiver's end.

As previously mentioned, the system allows for the simultaneous utilization of more than one information channel and also for dynamic shifts among channels. For instance, service information may be transmitted via an ftp protocol, the object is accessed via http, and all other constituents of the transmission are conveyed via POP3. In some embodiments, the information channel may change between an encrypted and non-encrypted regime within a communication session.

As previously mentioned, quants are the building blocks of information objects, i.e. the smallest piece of information content holder within a digital object. For instance, a pixel has four quants, including Red (R), Green (G), Blue (B) and Alpha (A). Upon transmission, the systems at the user's end allows for the creation and synchronization of different encryption keys for each quant. In an exemplary instance, when examining a graphic object consisting of 1024×680 pixels as the information carrier, each row element is classified as a unique Delta and each row is classified as an information container comprising 1024 Deltas. In this scenario, a crypto analyst would have to break 4 keys per each Delta, wherein in the exemplary instance, there are 680 transport containers comprising 1024 Deltas each Delta containing 4 quants. The present invention utilizes quants in multiple ways, including as a piece of an information structure object, or external information carrier, used for the creation of encryption keys as opposed to random numbers, and also as the smallest indivisible information structure in which information may be broken down to be transmitted wherein a different channel, convention, or encryption may be applied to each individual quant.

As previously mentioned, the system does not require secure channels of communication among points, as all transfers and communications are executed via open channels only, and devices, users, and/or data structures never share common secret information. In current encryption systems, senders and recipients need to exchange a secret key, a security certificate, or another means to decrypt and/or unlock the proprietary information. This makes current encryptions systems extremely vulnerable, as there is a need for an additional secure information channel which is not accessible to unintended users. The present invention overcomes these limitations, as the system allows a sender and a recipient within a communication session, or two data repositories, or a server and a cloud system, the ability to use a public communication environment such as the Internet or an unsecured e-mail protocol, and still achieve the highest security level.

It is a particular advantage of the present invention to consider outsider and insider risks equivalently, providing complete real-time protection from threats, wherein the threats may be systems and/or individuals with any degree of enterprise credentials, including executives and IT personnel, as well as dynamic shielding against information access, tampering, misplacement or disinformation. This is especially critical as insider risks remain the top security concerns across all industries and business functions. In one embodiment, the system prevents senior executives and/or IT personnel from gaining access to raw data, information flow, and decrypted archives. Similarly, the system prevents outside risks from accessing, collecting, or retaining any data piece, flow, or system setting.

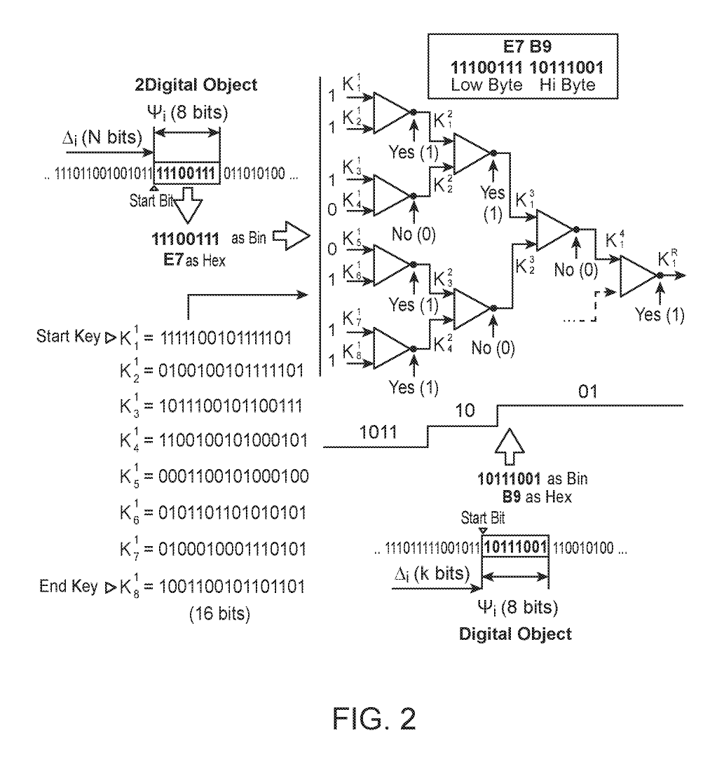

FIG. 2 is a diagram illustrating a method for encryption key generation according to an embodiment of the present invention. The method is an exemplary non-limiting model for encryption key generation with adders and inverters. Method uses a N-cycle sequence for generating a unique encryption key with a variable length. The unique encryption key may comprise both an even and odd number of bits. Referring to FIG. 2, the digital object key's shall be read in binary as follows:

1111100101111101
0100100101111101
1011100101100111
1100100101000101
0001100101000100
0101101101010101
0100010001110101
1001100101101101

### Level-1

111110010111110101001001011111011011100101100111110010010
100010101000100011101011001100101101101 (128 bit)

### Level-2

1110001011111001 → 1110100000110 (13 Bit)
1011100101100111
1010010010101010
110011010010010 → 15 (Bit)
111000101111100110111001011001111010010010101010110011010010
010 (60 Bit)

### Level-3

1110001011111001
1010010010101010

### Level-4

11100010111110011010010010101010 (32 Bit)

### Level-5

1110100000110 (13 Bit)

### RESULT—233 Bit Encryption Key (Word Length—12 UTF-8 Symbols):

11111001011111010100100101111101101110010110011111001001010
00101010001000111010110011001011011011110001011111001101110
010110011110100100101010101100110100100101110100000110

Said encryption key can easily be generated by a system comprising a standard integral scheme component. In some embodiments, there is an analog-to-digital converter (ADC) at the entry and a digital-to-analog converter (DAC) at the exit of the cycle. In another embodiment, the chips are set for one-time usage only in order to achieve the highest level of apparatus security. This can be accomplished with a piezo-crystal component programmed to respond to specific input signals that trigger a straightforward purge of the apparatus component at the end of the cycle or session.

Cryptographic Algorithm

In one embodiment, the encryption key must have random, discrete distribution, described with the equation:

$${P}_{k} ( k ) = \frac{1}{{2}^{N}} \qquad ( 1 )$$

In equation 1, Pₖ (k) is the probability of a random realization of the encryption key; k is the encryption key; and N is quantity of the binary symbols that sustain the encryption key. In one embodiment, the number of the symbols in the encryption key needs to be equal to the number of symbols contained in the exposed text. In one embodiment, every single encryption key is used only once.

Resistance of the One-Time Pad Algorithm to Crypto Attacks

In one embodiment, an exposed text can be represented as a series of binary symbols with length:N:m=m₁, m₂, . . . , mₙ, wherein the distributed probability for the exposed text Pₘ(m) may accept random values.

In one embodiment, the encryption key is represented as a binary sequence K:k=k₁, k₂, . . . , kₙ with the same length but with discrete distribution Pₖ(k) and the encrypted message is formed as every single component from the exposed text is summed by modulo 2 (operation “exclusive OR”) with component from the encryption key. C=M⊕K=m₁⊕k₁, m₂⊕k₂, . . . , mₙ⊕kₙ. The recipient using the encryption key decrypts the encrypted message. M=C⊕K=c₁⊕k₁, m₂⊕k₂, . . . , mₙ⊕kₙ. In one embodiment, the probability distribution for all blocks, that form the encrypted text are defined by the equation:

$$\begin{matrix}P ( c = a ) = P ( m ⊕ k = a ) \\ = {\sum }_{n}^{ } P ( m ) P ( m ⊕ k = a \vert m ) \\ = {\sum }_{n}^{ } P ( m ) P ( m ) \frac{1}{{2}^{N}} \\ = \frac{1}{{2}^{N}}\end{matrix} \qquad ( 2 )$$

The results from equation 2, confirm that the sum of two random values, one of which is evenly distributed is a random value that will also be randomly distributed, thus, the distribution in the encrypted message is even. In one embodiment, the distribution for the exposed text and the encrypted text is given with the following formula:

P(m=a,c=b)=P(m=a)=P(c=b|m=a) (3)

The conditional distribution in this case will be:

$$P = P ( M , C ) ∀ P ( {m}_{i} = {a}_{i} , {c}_{j} = {b}_{j} ) = P ( {m}_{i} = {a}_{i} ) \frac{1}{{2}^{N}} \qquad ( 4 )$$

Since, the encryption key and the exposed text are independent random values, it may be deducted that:

$$P ( c = b \vert m = a ) = \frac{1}{{2}^{N}} \qquad ( 5 )$$

When replacing the right-hand side of the equation with formula 5:

$$P ( m = a , c = b ) = P ( m = a ) \frac{1}{{2}^{N}} \qquad ( 6 )$$

This proves that the encryption text is independent from the exposed text, guaranteeing the execution of the condition for complete crypto resistance.

Algorithm of the BS Cipher

In one embodiment, a BS (block size) cipher may be considered a modified one-time pad cipher, wherein the difference is in the availability of the “consistency function”, which is formed dynamically in the processes of encryption and decryption and having a purpose to define a temporary set of rules for the consistency in the process of reading the exposed text. In one embodiment, the exposed text for each message may be presented as a set of two-dimensional matrices of the type:

$$\begin{matrix}{M}_{1} = \vert {m}_{1}^{1} , {m}_{2}^{1} , {m}_{3}^{1} , … {m}_{i}^{1} … {m}_{m}^{1} \vert \\ {M}_{2} = \vert {m}_{1}^{2} , {m}_{2}^{2} , {m}_{3}^{2} , … {m}_{i}^{2} … {m}_{m}^{2} \vert \\ … \\ {M}_{q} = \vert {m}_{1}^{q} , {m}_{2}^{q} , {m}_{3}^{q} , … {m}_{i}^{q} … {m}_{p}^{q} \vert\end{matrix} \qquad ( 7 )$$

In most embodiments, the number of elements of the matrices that built the set will be subject to the condition_m≠n≠ . . . ≠p.

In one embodiment, the encryption key may be represented as a set of one-dimensional matrices, wherein the elements are randomly and evenly distributed and subject to the condition.

$$\begin{matrix}{K}_{1} = \vert {k}_{1}^{1} , {k}_{2}^{1} , {k}_{3}^{1} , … {k}_{i}^{1} … {k}_{m}^{1} \vert \\ {K}_{2} = \vert {k}_{1}^{2} , {k}_{2}^{2} , {k}_{3}^{2} , … {k}_{i}^{2} … {k}_{m}^{2} \vert \\ \vert … \\ {K}_{q} = \vert {k}_{1}^{q} , {k}_{2}^{q} , {k}_{3}^{q} , … {k}_{i}^{q} … {k}_{p}^{q} \vert\end{matrix} \qquad ( 8 )$$

Every matrix from the exposed message is juxtaposed a matrix from the encryption key as follows:

∃Mᵢ=|m₁ⁱ,m₂ⁱ,m₃ⁱ, . . . mᵢⁱ . . . mₘⁱ|, Kⱼ=|k₁^{j},k₂^{j},k₃^{j}, . . . kᵢ^{q} . . . kₘ^{j}| (9)
wherein the following conditions are fulfilled: i≠j and n≧m, e.g. the number of the elements of the matrix of the encryption key is greater or equal to the number of elements of the matrix of the exposed text.

In one embodiment, the encrypted message contains a set of one-dimensional matrices (vector row) of the type:

$$\begin{matrix}{C}_{1} = \vert {c}_{1}^{1} , {c}_{2}^{1} , {c}_{3}^{1} , … {c}_{i}^{1} … {c}_{m}^{1} \vert \\ {C}_{2} = \vert {c}_{1}^{2} , {c}_{2}^{2} , {c}_{3}^{2} , … {c}_{i}^{2} … {c}_{m}^{2} \vert \\ … \\ {C}_{q} = \vert {c}_{1}^{q} , {c}_{2}^{q} , {c}_{3}^{q} , … {c}_{i}^{q} … {c}_{p}^{q} \vert\end{matrix} \qquad ( 10 )$$

Each of the matrices that build the set of the encrypted text is formed as each one from the elements of the matrix Mi is summed by modulo 2 with the corresponding element from the matrix Kj, as follows:

Cₖ=Mᵢ⊕Kⱼ→cₖ=mᵢ⊕kⱼ, (11)

Furthermore, each index of the matrix of the exposed text is a juxtaposed index from the encryption key matrix, since these two indexes from an ordered pair of integers are recorded in a dynamic matrix of the relationship between elements of the exposed text and elements of the encryption key matrix, so that the following condition is fulfilled:

∀mᵢεMkⱼεK,cₖ=mᵢ⊕kⱼεC,∀mᵢ̂kⱼ→τₖ(i,j), (12)

where rₖ(i,j)−k-th element of the relation matrix R, which contains information about the index of the element of the matrix belonging to the set of matrices that form the exposed text and the index of the matrix belonging to the set that forms the encryption key.

Recognition

In one embodiment, an exposed text may be presented as a set comprising one array as follows:

M₁≡|m₁¹,m₂¹,m₃¹, . . . mᵢ¹ . . . mₘ¹| (13)

which contains M-number of elements, and an encryption key is generated comprising once matrix:

K₁≡|k₁¹,k₂¹,k₃¹, . . . kᵢ¹ . . . kₘ¹| (14)

which contains N-number of elements and the condition N>M is fulfilled, since the number of elements of the matrix of the encryption key is larger than the number of elements of the matrix of the exposed text. In one embodiment, the process of generating elements of the encrypted message is subject to the following formula:

c₁^{k}=m₁ⁱ⊕k₁^{j} (15)

In one embodiment, the corresponding element of the relation matrix will be formed during the encryption process by the formula:

r₁₁=jεk₁^{j} [symbol] r₁₂=iεm₁ⁱ (16)

Likewise, during decryption by the dependence:

r₁₁=jεk₁^{j} [symbol] r₁₂=kεc₁^{k} (17)

The encryption process may be described by the equation:

C₁=K₁⊕M₁ [symbol] ∀:(c₁^{k}=k₁^{j}⊕m₁ⁱεC₁) [symbol] (k₁^{j}εK₁ [symbol] m₁ⁱεM₁) (18)

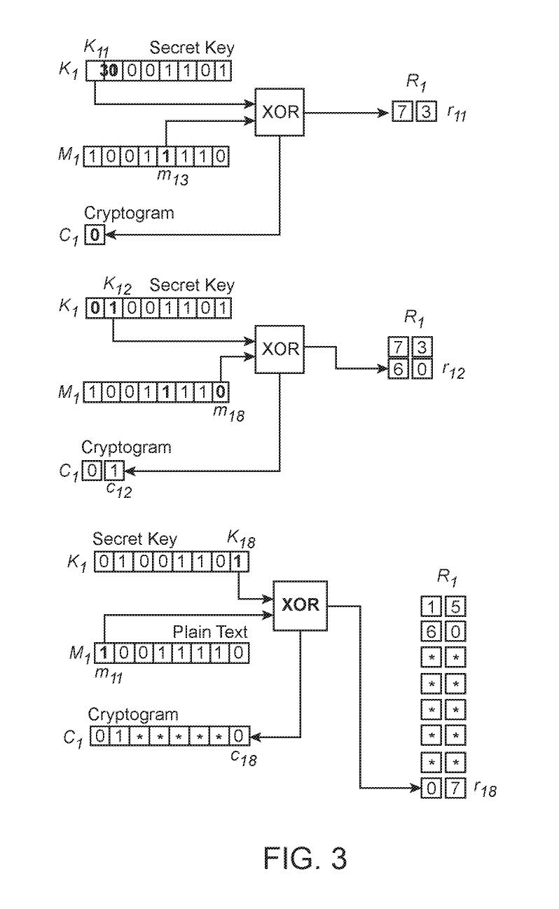

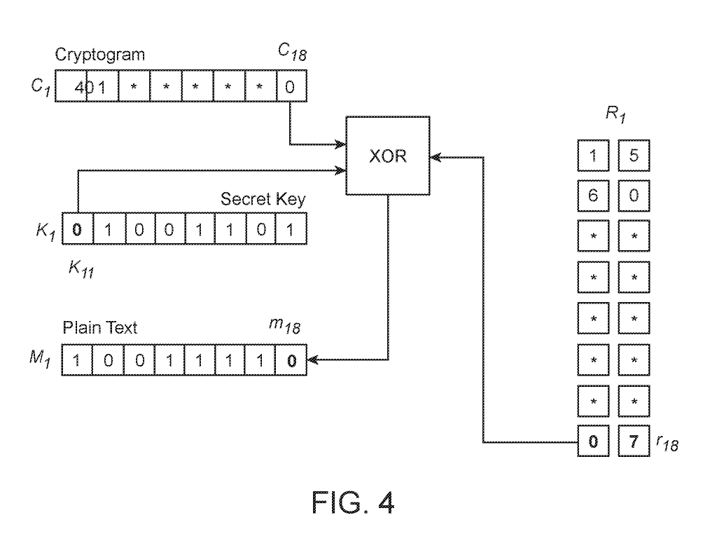

FIGS. 3 and 4 are diagrams illustrating an encryption matrix according to an embodiment of the present invention. Referring to FIG. 3, the encryption process is illustrated comprising a matrix having eight elements each of which contains one byte of information. In one embodiment, the number of available combination for the rearrangement of elements of M₁ is defined by the formula below:

[symbol]

=n^{k}=2⁸=256 (19)

In one embodiment, the decryption of the encrypted text demands that index j is located first to which the subsequent element from the encryption matrix corresponds, and also index i to which the element from the encrypted message matrix corresponds, and with those indices j and i to perform the transformation:

m₁ⁱ=k₁^{j}⊕c₁^{k} (20)

In this case, k-index is executed to the equality: k=j, for all the elements of the array, belonging to the set forming the encryption text. Since, two indexes are used in the processes of encryption and decryption this scheme is called a binary scheme. Referring to FIG. 4 the encryption process is illustrated comprising a matrix having eight elements each of which contains one bit of information. It is understood, that the actions previously described herein may be performed on an unlimited number of one-dimensional matrices, as long as the following condition is satisfied: the number of matrices that belong to the set of matrices that form the exposed text to be equal to or smaller than the number of matrices from the set that form the encryption key.

Resistance of the BS Cipher to Crypto Attacks

Since all of the elements of each matrix from the set of the matrices forming the encryption text are represented by a random uniform distribution the one-time pad cipher is applicable to the current case as the following condition is satisfied:

$$P = P ( M , C ) ∀ P ( {m}_{i} = {a}_{i} , {c}_{j} = {b}_{j} ) = P ( {m}_{i} = {a}_{i} ) \frac{1}{{2}^{N}} \qquad ( 21 )$$

It should be understood, that when utilizing the algorithm with encryption keys of a length higher than 2048 bits, the matrices are replaced with linear lists to improve performance.

Generation of Encryption Keys by Using Open Communication Channels

As previously mentioned the present invention overcomes the problems of existing systems for the generation of encryption keys by introducing integrated routines to generate a common encryption key during the information exchange process and using only open communication channels without the need to exchange secret or classified information. The generation of a common encryption key using an open communication is made possible by a phenomenon recognized as ‘quantum effect of random events’ which is the deviation from the usual behavior of each component of the object, which triggers a set of random events. According to the law of large numbers, given common conditions, the joint impact of a large number of random factors leads to results that are less dependent on the randomness, according to the following relation:

$$P \{ \vert \frac{{μ}_{n}}{n} - \overline{p} \vert > ɛ \} -> 0 \qquad ( 22 )$$

From this relation comes that for an arbitrary ε>0 the frequency of realization probability converges to the average probability. This law is in power only for objects that comprise a big number of elements. The system and method for the encryption key generation is based on the usage of this effect.

The quantum effect of random events can be calculated by analyzing the usage of fuzzy logic in a control system or in the development process of software applications. In classic mathematical logic each logical function can be presented in disjunctive or conjunctive normal form in the usage of the three main operations as it follow: conjunction (OR); disjunction (AND) and negation (NOT). In fuzzy logic instead of the traditional final values [0, 1] (false, true) is used the value “degree of truth” which can take endless set of values/meanings in the limited interval μ[0,1] as well known in the art. Furthermore, operations cannot be presented in a tabular form but instead they are presented as functions as follows:

OR is represented as Max−function−x₁ [symbol] x₂ [symbol] max(x₁,x₂)=x₁, in x₁>x₂; x₁ [symbol] x₂ [symbol] x₁+x₂−(x₁xx₂);

AND is represented as Min−function−x₁ [symbol] x₂ [symbol] min(x₁,x₂)=x₁, in x₁>x₂; x₁ [symbol] x₂ [symbol] x₁+x₂;

NOT is presented as function−−x₁=1−x₁

The process from fuzzy to classical logic is common during the quantum system process. While the system evolves according to the Schrödinger equation, its state changes continually and in a deterministic fashion. Each external impact on the system causes a quantum jump and the system goes to one of it discrete states. It is accepted that the transition from a fuzzy to a real logic value is called, “defuzzification”. The calculation of the real value of the defuzzificated signal can be calculated by both the maximum value and by calculating the weight amounts for all the rules (centroid), which is done by the formula:

$$Z = \frac{{\sum }_{1}^{n} {F}_{i} {S}_{i}}{{\sum }_{1}^{n} {F}_{i}} \qquad ( 23 )$$

wherein Z is the real value of the output variable; Fi—Value of pertinence to the relevant output variable; and Si—Maximum value of the relevant output value.

Exchange Session

A lack of a secured channel between correspondents does not rule out the option for transmitting exposed messages, as nothing prevents transmission of information that is not critical and that does not need to satisfy the confidentiality conditions, but which is used as an element during the generation of the encryption key. If M is the exposed text, and K the encryption key, the encrypted message C will be a function of M and K:

C=f(M,K) (24)

In embodiments with different encryption keys, there will be different encrypted messages:

Ci=f(M,Ki)≠Cjf(M,Kj),Ki≠Kj. (25)

For each encrypted message (encryption text) the critical information is the one that has a firsthand relation to the used encryption key but not the information concerning the exposed text, assuming that the encryption algorithm is well known. In practice the encryption text can be treated as a container in which the encryption key is stored.

Proceeding from the previous conclusions, it can be accepted considering two exposed messages M₁ and M₂ for which the following conditions are satisfied: The length of M₂ is bigger than the length of M₁; M₂ contains M₁ under a certain form; and M₂ is a container for M₁. According to the fuzzy logic view point M₁ is a typical fuzzy set, since it can be represented as a percentage of the set of M₂.

The following is an exemplary instance of the above mentioned principles. There are two correspondents A and B in which an informational exchange is initiated. Assuming, correspondent A selects at random a digital image D, which can be considered a two-dimensional array D[m, n] for which each element d(I,j)εD is with a length of 24 bit. Assuming, that what is generated as the output of correspondent A gets unaltered to the input of correspondent B and vice versa. Next, the image will be transmitted from correspondent A to correspondent B and vice versa as a linear sequence of elements d(I,j)εD, each one having a fixed length. The process in which the information received from correspondent B is further transmitted to correspondent A can be called feedback. Next, the information received from the correspondents goes through a digital filter with an endless in time impulse response, which can be described with the equation:

$$y ( n ) = {\sum }_{i = 0}^{P} {b}_{i} x ( n - i ) - {\sum }_{k = 1}^{Q} {a}_{k} y ( n - k ) \qquad ( 26 )$$

wherein, x(n) is the input information; y(n) is the output information; bi is the coefficient of input information; ai is the feedback coefficient; P is input information class; and Q is the feedback class. Values for y(n) are functionally dependent on the values of the coefficients ai and bi, which are different at each iteration. In practice this is a typical quantum system that functions according to the Schrödinger equation.

Next, a fuzzy logic analysis at the input of the two corresponds is performed for correspondents A and B respectively:

$$\begin{matrix}\overline{A} = {\sum }_{i}^{n} \frac{{μ}_{\overline{A}} ( {x}_{i} )}{{x}_{i}} & ( 27 ) \\ \overline{B} = {\sum }_{i}^{n} \frac{{μ}_{\overline{B}} ( {x}_{i} )}{{x}_{i}} & ( 28 )\end{matrix}$$

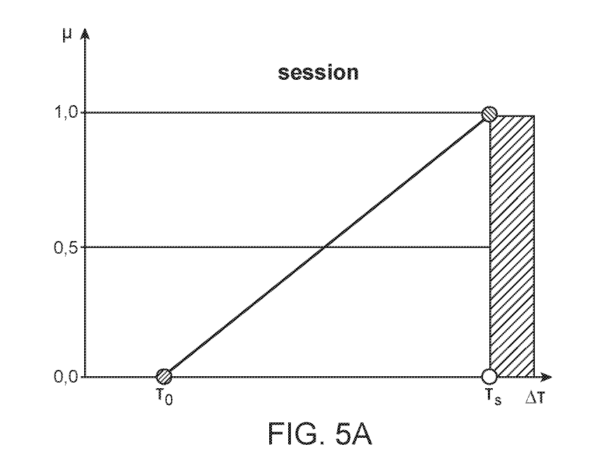

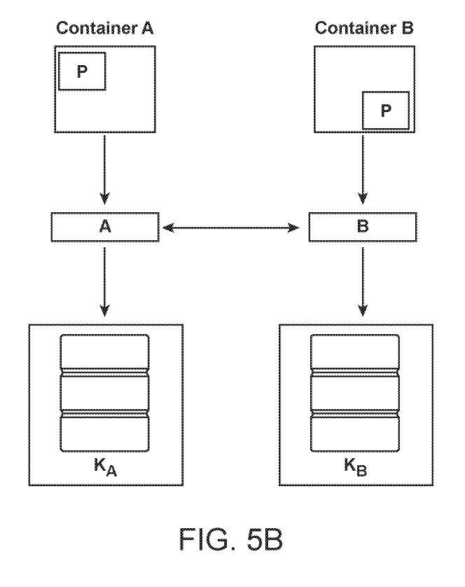

Next, the exchange between A and B is synchronized, as it is required to mark the start moment and after which the character of the information exchanged is altered, such as from graphic to text, practically this can be realized in the moment in which μ_{Ā}=1 [symbol] μ_{B̅}=1. Analysis of this example leads to the conclusion that an encryption key over an open communication channel was successfully transmitted by using a digital image and a digital filter with endless time range impulse response. Assuming a digital image is provided having an encryption key length of 890,880 bit, the same digital image may be interpreted as a digital container storing 435 encryption keys, each having a length of 2048 bit or 870 encryption keys each having a length of 1024 bit. Referring now to FIG. 5A, the dynamics of the process described is illustrated.

Algorithm for the Generation of the Encryption Key

In the previous example, it was assumed that once a given moment τₛ is reached for which μĀ=1 [symbol] μ_{B̅}=1, the exchange process alters its nature. It shall be understood that in practice this is not mandatory, as the exchange can continue for an unlimited time before a regime shift is triggered. Based on the considerations presented above, a robust algorithm for generating a set of unique encryption keys by using an open communication channel is attainable. It should be noted that in such case the process of generation of the encryption key and the process of its transmission are bundled in a single process described in greater detail below.

FIG. 5B is a diagram illustrating a process of generating and exchanging encryption keys using an open communication channel for exchanging information according to an embodiment of the present invention. Referring to FIG. 5B, a set of encryption keys for each of the correspondents K_{A} (K₁^{A}, K₂^{A}, . . . , Kₙ^{A}) and K_{B} (K₁^{B}, K₂^{B}, . . . , Kₙ^{B}) will be used in the process of exchanging of encrypted messages.

The processes for generating sets of encryption keys and the process of encryption and exchange are separated in a given time interval. Each of these processes has a “beginning” and an “end” and, taking into account the security of the exchange process, the sequence is setup so that each subsequent process starts only after it was confirmed that the previous process was successfully completed. Let us assume that each of the correspondents in the exchange is able to pick a random digital object stored outside the system the properties of which may be transformed into an information stream. This information stream is denoted as T_{A} for correspondent A, T_{B} for corresponded B, and the time intervals are denoted as τi. The information streams will be utilized as information containers, through which we shall execute the information transmission of useful information P_{A} and P_{B} where the condition μ_{A}<<1 [symbol] μ_{B}>>1 is satisfied until the moment where μ_{Ā}=1 [symbol] μ_{B̅}=1. It should be noted that the transmission of useful information by using containers is different from the steganography processes as the present method and system concerns solely transmission under certain conditions and hiding of information is not considered.

Assuming that a feedback between the correspondents is feasible such that in every moment correspondent A can receive information for the message received by correspondent B. In the common case, the function of exchange of encrypted message may be represented as:

f[M(τ−1),K(τ),C(τ)] (29)

wherein M(τ−1) is the exposed message, K(τ) is the encryption key, and C(τ) the encryption text.

When generating encryption keys by using open communication channel for information transmission and exchange, from the moment of starting the session to the moment when the encryption key is generated, will be presented as:

f[M(τ−1),T(τ),P(τ)] (30)

The algorithm for the generation of a random encryption key is based on the following: upon the opening of a working session correspondent A sends information stream T_{A} to correspondent B which information stream is a transport container for the useful information; transforming or filtering the information stream T_{A} is initiated at both A and B until the condition μ_{Ā}=1 [symbol] μ_{B̅}=1 is fulfilled; the useful information is extracted from the transport container and the system runs specific checks on its uniqueness when the state μ_{B̅}=1 is reached; when the transmitted useful information fulfills the uniqueness criteria it is added to the list of unique encryption keys K_{B} (K₁^{B}, K₂^{B}, . . . , Kₙ^{B}); correspondent B sends information stream T_{B} to correspondent A serving to indicate that the filtration process T_{A} is complete such that correspondent A performs a check whether the condition μ_{Ā}=1 is fulfilled; if μ_{Ā}=1, correspondent A extracts useful information from the transport container and runs specific checks on its uniqueness; when the transmitted useful information fulfills the uniqueness criteria it is added to the list of unique encryption keys K_{A} (K₁^{A}, K₂^{A}, . . . , Kₙ^{A}); if it is identified that the received unique encryption key is not unique, correspondent A sends information stream T_{A} to correspondent B indicating that the transmission was not successful; if correspondent B receives a marker for unsuccessful transmissions correspondent B either discontinues the exchange or undertakes additional actions depending on the particular implementation and/or rules; and if correspondent A wants to end the session, a transport container with pre-set properties is sent, such as μ_{Ā}>0.5, wherein the session may be ended by correspondent B in analogous manner.

In one embodiment, the algorithm may be used with systems that utilize more than one information channel by a strict compliance to the requirement for exchange synchronization.

It should be noted that if digital images or audio signals are used as transport containers the disadvantages related to triggering of autoregressive processes are overcome, because in practice the containers will generate flicker (pink) noise given the character of the information they store and more importantly due to its volume.

In the previously described algorithm, the correspondents perform constant encryption key exchange and generation in a timesharing process and/or by using more than one channel for information transmission. Each new encryption key can be added to or replace an existing one, guaranteeing the dynamic renewal of the encryption keys during the information exchange process. If the length of the received encryption key is larger than the length of the encrypted message at each iteration, a new encryption system is generated and utilized at each subsequent step which fulfills the requirements for perfect secrecy as proven by Claude Shannon within the context of a robust practical implementation.

Best Mode of Utilization of the Encryption Model

In the process of exchanging encrypted messages users have to regularly initiate a procedure for the generation of a new common encryption key, which will replace the encryption key in use at the current moment. In this process the information needed for generating the service information (the information for the session, devices, interfaces, sockets, etc.) is added to the stream of useful information (the useful information can be encrypted, non-encrypted or a combination of both). This process happens by periodical interruptions of the stream within the range of one session or by using N channels on a physical or a logical layer. Thus, the secret key is renewed multiple times during the session. The instances of renewing of the encryption key for the users are proportional to the number of the elements by which the data stream is built. The service information creates some prerequisites for additional load to the data transfer channels and requires that the information is separated by logical or time criteria/conventions, creating the need of implementing a procedure for optimizing the information stream. The interchange of small Li bit messages is not a solution, since it limits the size of the encrypted text, thus an appropriate implementation would be the utilization of a packet data transfer regime by using a digital communications channel.

From the encryption key generation mechanism described above, it is clear that each simple Li bit key can be simultaneously and synchronously generated at the users' end in each moment τi. So, for every τi all NK packages of encrypted service information or information transmission elements (each information package can be broken down to a discretionary N number of pieces where each piece is encrypted by its own key where the limit of the N number is related to the bit as the lower boundary for each individual piece length) will have the ability to be grouped in one message with a length:

L=NK×Li (31)

In this scenario the users will exchange T number of packages with a length of L bit, i.e. they will exchange information containers. Each of these containers can be added as an element of a package of useful information. Breaking the useful data stream in small packages (Delta Data containers or just Deltas) fulfils the Shannon theorem, the maximum rate at which information can be transferred as well known in the art, for each piece of the transmission denoted as quants in order to get to a unified representation for analogue and digital objects.

Continuing from the above conclusion, estimating the ratio between service information and useful information must be considered, including the real volume of service information transmitted which would exceed the volume of useful information by a large factor, since not all deltas would contain a useful element. In many cases this can as well be an artificially generated process with the purpose to achieve disinformation of the crypto analyst. For a particular delta to contain useful information, it is important that said delta should not only transmit an encryption key, but should also allow for the execution of the function for the next layer in the hierarchy of the crypto system.

To generate a L-bit common encryption key at user's end the following volume of information needs to be exchanged: V=2×T×L [bit], wherein V is the calculated or forecast volume of the exchanged data. The actual volume of the exchanged information V_{fact} can be calculated by using the success probability of the series P_{suc} according to the axiomatic definition:

$${P}_{SUC} = \frac{V}{{V}^{fact}} \qquad ( 32 )$$

for each of the probabilities P_{suc}, such that:

$${V}^{fact} = \frac{V}{{P}_{SUC}} = 2 \times T \times \frac{L}{{P}_{SUC}} \qquad ( 33 )$$

For a large enough length T (large number of information containers) this probability will also be high enough.

In one embodiment, when applying a first-time analysis it is advisable to use the formula:

V_{fact}≈V=2×T×L (34)

which is the volume of service information added for an exposed text with a L-bit length if it is being encrypted with an encryption key. The part of the service information for one bit will be approximately equal to 2×T, but considering if the common convention with stream-based encryption calling for a generation of a key sequence (K₁, K₂, . . . , Kₙ) from the secret key K, the length of the encrypted text can be increased to 2^{L}−1 bit. The process can be viewed as a cryptographically powerful generator with a length of 2^{L}−1. From this point the volume of the service information for a 1-bit text message will be as follows:

$${L}_{Text} \approx 2 \times T \times \frac{L}{{2}^{L}} \qquad ( 35 )$$

When reviewing potential threats to the system, first are the attempts for the interception of the encrypted messages and their further decryption, by determining the encryption key common for the users. Second threat would be the replacement or impersonation of one of the users. In this case the crypto analyst will have the ability to control, manipulate and replace/falsify the whole or part of the exchanged information (disinformation process). The usage of two encryption keys provides a higher level of protection in case of replacement of one of the correspondents. The system has routines to counter such type of attack. In practice these methods are an integral part of the encryption keys exchange protocol.

At the moment when the connection is established, the correspondents are able to exchange personal data markers (personal wave) in an encrypted format, after the common key is generated. These markers allow for performing periodical checks for each subsequent session of the data exchange. Despite that, the threat of replacement of the correspondent (operator) that initiates the session remains. In this case, a set of event commands are used, to which the correspondent is supposed to react in a certain pre-defined fashion. If this does not happen the communication channel is considered compromised and certain action sequences are triggered based on the particular system setup.

In scenarios where a collective channel for exchange of encrypted messages is used, such as with mobile communications, it is important to monitor the connectivity of each user to the channel and also to analyze the fluctuations, throughput, data packet sizes etc.

Now considering potential crypto attacks whose purpose is to decrypt the information from the crypto analyst side. Assuming the crypto analyst has unlimited computing resources, unlimited time and with that, the ability to execute a full set of actions by which to receive the encryption key common for the correspondents from the captured encrypted messages (the number of which is also unlimited). The attempt to receive the encryption key on the basis of the intercepted service information will fail if the probability to get the true (original) encryption key is close to zero. This statement holds true also in cases when the crypto analyst gets direct access to the exposed text (via extortion, treason, exporting secret information out of its storage range, etc.). Since for each element of the exposed text a unique encryption key is generated, the crypto analyst would needed to receive the whole set of encryption keys for the specific message in order to achieve the decryption result. Thus, the only reasonable way which a crypto analyst could explore in such case is to decrypt the intercepted useful information, by non-algorithmic rationalizing of the exposed text.

To evaluate this process, we shall use the concept entropy of the set of words, for words which have a meaning H_{S} and the information surplus in the communication language D denoted as redundancy language of communication. We shall define “a meaningful word” as a word or a symbol string with a minimum length that was created by using the symbol set of the alphabet of one specific language or technical interface and has a meaning within the usage of said language or technical medium. Furthermore, let us suppose that the crypto analyst has a perfect command of the language and possesses a full vocabulary of that. Let us assume that there is an attempt to decrypt a part of the encrypted text with a length of one meaningful word. By performing a complete analysis of all the available results, the crypto analyst will get an enormous quantity of meaningful words or maybe the whole vocabulary. If this is performed over a few fragments of exposed text encrypted with the same encryption key, the probability to identify repeating instances of meaningful words is increasing. In practice, this could be used as the starting point for finding the encryption key used for all the intercepted fragments. Useful for the crypto analyst's purpose is the fact that the multitude of meaningful words is a subset of all of the words that have the same length and are constructed on the basis of the alphabet of the specific language. However, to decrypt the intercepted information the crypto analyst would need to repeat this process for each element of the encrypted text where the length of each such element should be equal to the length of one meaningful word and the same encryption key to have been used for all the elements (the ideal case for the crypto analyst). Thus, in order to guarantee the security of the encrypted message, the system must allow for renewing of the encryption key for each meaningful word or a data element.

In scenarios wherein a written text is exchanged, the typical “word” contains approximately 8 symbols (taking into account also the numeric symbols) corresponding to an encrypted text with a length of L_{W} 128 bit when using Unicode (L_{W}=8×16). In practice L_{W} is the entropy of all of the available eight-letter words compiled by the alphabet of a language. The entropy of a set of meaningful words H_{S} is defined from L_{W} and D, defined by the Shannon theorem and approximately equal to 3.5, where:

$${H}_{s} = \frac{{L}_{w}}{3.5} = \frac{128}{3.5} \approx 36.57 \approx 36 bit ( 3 a Unicode ) \qquad ( 36 )$$

The numerical values for HS, LW and D are comparable for every language with a written representation. A decryption engine based on the principles of meaning would suppose that the crypto analyst will have a vocabulary of at least μS=2^{Hs}=2³⁶=6,871,947,676 words.

In order to prevent such an attack, the common encryption key needs to be renewed for every piece of useful information (a “word” or a data piece with a length of 16, 32 or 128 bit). The length of the service message will be 2×T times larger than the length of the useful information. In the above example, it will be 256 bit for every 2 bit of useful information. Adhering strictly to the exchange protocol it is possible to trigger a communications channel overload, which is unacceptable. Thus, when transmitting text information, a balance needs to be found between the maximum load (which is a function of the dimensionality of the information stream and the setup of the encryption system) and the crypto resistance parameters. However with voice and video transmission as in the case with telephone and mobile communications, we consider a different setting. In the voice transmission process one meaningful word is pronounced in about 0.5 seconds and is coded in 3÷5 Kbit. At the same time the correspondents exchange as much service information as they do in a typical text exchange (2×T×log 2LW). Thus, there is a huge surplus of transmitted service information compared to the secret information. The case with video streaming is analogous. One video frame is transmitted in about 0.02 seconds and is encrypted in 100±300K bit digital information.

The information surpluses defined above, are primarily the result of the willingness to transmit not only the core “signal” or information content, but also subtleties that are of importance to the human senses and the comprehensiveness of the perception such as tone, pitch, timbre, accents, etc. When this information noise is utilized as an element in the encryption system, its sheer volume would enable the creation of powerful and attack-resistant crypto systems. Indisputable is the fact that it is extremely difficult to compile complete “dictionaries” of the audio/video information that is created, used and kept available and that can eventually be used as a basis for the crypto analysis. When file transfers, databases and local storage arrays are concerned, it is useful to apply a hybrid approach as the meaning of the digital or graphical fragments can be exhibited and processed only with large volumes of information. In brief, robust encryption remains most difficult with written text due to the relatively low (compared to the other types of information exchange) scale of information redundancy. In such case, in order to position the implementation closer to the entirely secret system domain, it is required to increase the scale of the information stream. The encryption of audio/video information and data files does not mandate such activities because of the character of the information mix and allows for the generation of a system exhibiting perfect secrecy properties. The algorithm for the generation of and transmission of a common secret key between the correspondents is not complicated and its realization has minimal apparatus and program requirements. In order to unify the encryption process a mechanism with temporary storage of the encrypted text might be implemented. Such type of setup would be appropriate in the context of mobile communications. As a random keys generator the system implementations can utilize physical generators of pulse noise (pulse generators) and also apparatus fluctuations of the used devices (pink, noise, etc.) or program generated fluctuations (white noise).

### CONCLUSION

A method and algorithm for the generation of a common encryption key between one or more correspondents for exchange of service messages by using open communication channel is provided. The encryption key is used by the users to encrypt useful, user- or administrator-defined information within a cryptosystem with a symmetric key. The data that needs to be securely transmitted can be broken down to its smallest indivisible elements denoted as quants and each such element can be encrypted with a separate encryption key that is dynamically created within a communication session. Digital objects that can be external to the system are used for the generation of the encryption keys and the generation of each encryption key is based on the smallest indivisible information structure of the digital object that is also denoted as quant. This quantification process can be applied to provide for a secure transmission of both structured and unstructured data—files, streams, interfaces, data transfers or archives. Any information structure can be subject to the set of quantitative and logical transformations performed by the system and enabling the secure transmission. It is important that in any case the quant length of the modifier is larger than the quant length of the modified. The encryption key that is common for the correspondents is renewed by transmitting service information (trivial information or data piece considered as noise for the purposes of the encrypted communication) and useful information bundled in information containers which can be of fixed or variable length. Crypto attack resistance is secured even under the assumption that the crypto analysts at the intruder end possess unlimited computational resources. The system stability and crypto penetration resilience is due to the inability of any out-of-session recipient to gather enough mass of the so-called service (or ‘trivial’) information so as to crack or recompile the encryption keys. The service information used for each session can in no way be linked to the crypto analysis method. The system resilience can be qualitatively assessed with proven quantitative analysis and applied statistics tools based on the probability of capturing of an encryption key by an out-of-session party. The proposed algorithm and implementations present a novel concept where there is no need to store the generated encryption keys or access those in any close form. Storage or archiving can be done only if this is mandated by specific rules and policies or by case specifics, otherwise the active keys are replaced by a higher-order key and the last-active one is automatically erased. Thus, no encryption key can be stolen or replaced by any party including the current users as such encryption keys exist only within the working session. The proposed algorithm enables completely autonomous implementations where each of the processes related to encryption key generation, processing and modification of the data and the actual transmission, is independent. Also, there is no need for external operators, information or communication channels, or protocols. The system is closer by its properties to the perfectly-secret systems without the need of excessive apparatus or program resources.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

What is claimed is:

1. A method for encrypting digital data, comprising steps:
(a) generating a encryption key, wherein the encryption key is generated during an information exchange process between one or more session participants using an open communication channel;
(b) synchronizing the encryption key to encrypt defined information within a cryptosystem with a symmetric key; and
(c) renewing the encryption key by transmitting service information and useful information bundled in information containers, wherein service information is a trivial data piece consisting of information noise.

2. The method of claim 1, wherein step (a), the information exchange process can dynamically switch between an encrypted and non-encrypted regime.

3. The method of claim 1, wherein step (a), the digital data that is encrypted is broken down to a number of identical or heterogeneous information slices denoted as quants which can be as little as the smallest indivisible information structure for the digital data.

4. The method of claim 3, wherein each quant can be encrypted by a separate encryption key.

5. The method of claim 4, wherein the encryption key comprises a N-bit length having an even or odd number of bits, wherein the encryption key may be dynamically changed or renewed in equal or varying time intervals.

6. The method of claim 5, wherein the N-bit length of the encryption key is larger than the length of the quant of digital data that is being encrypted.

7. The method of claim 1, wherein step (a), a digital or analogous object is broken down to its smallest indivisible information elements.

8. The method of claim 7, wherein the digital or analogous object is a picture, text, audio, video, website element, television report, live performance, medical means, chemical compound, or any element with a clear information structure.

9. The method of claim 7, wherein the smallest indivisible information elements of the information structure of the digital or analogous objects are used for the generation of the encryption keys.

10. The method of claim 7, where the digital or analogous objects are accessed by the session participants via independent open channels.

11. The method of claim 1, wherein step (c), the information containers comprise a fixed or variable length.

12. A system for encrypting digital data comprising:
a network connected computerized appliance having a processor and coupled to a data repository, the processor executing software from a tangible medium, the software providing an interactive interface to an encryption system, the system enabling a session participants to:
log on and exchange information comprising digital data with other session participants, wherein the digital data is encrypted comprising steps:
(a) generating a encryption key, wherein the encryption key is generated during the information exchange between the session participants using an open communication channel;
(b) synchronizing the encryption key to encrypt defined information within a cryptosystem with a symmetric key; and
(c) renewing the encryption key by transmitting service information and useful information bundled in information containers, wherein service information is a trivial data piece consisting of information noise.

13. The system of claim 12, wherein step (a), the digital data that is encrypted is broken down to a number of identical or heterogeneous information slices denoted as quants which can be as little as the smallest indivisible information structure for the digital data.

14. The system of claim 13, wherein each quant can be encrypted by a separate encryption key.

15. The system of claim 14, wherein the encryption key comprises a N-bit length having an even or odd number of bits, wherein the encryption key may be dynamically changed or renewed in equal or varying time intervals.

16. The system of claim 15, wherein the N-bit length of the encryption key is larger than the length of the quant of digital data that is being encrypted.

17. The system of claim 12, wherein step (a), a digital or analogous object is broken down to its smallest indivisible information elements.

18. The system of claim 17, wherein the digital or analogous object is a picture, text, audio, video, website element, television report, live performance, medical means, chemical compound, or any element with a clear information structure.

19. The system of claim 17, wherein the smallest indivisible information elements of the information structure of the digital or analogous objects are used for the generation of the encryption keys.

20. The system of claim 17, where the digital or analogous objects are accessed by the session participants via independent open channels.
